(19) United States
(12) Patent Application Publication
(10) Pub. No.: US 2017/0295874 A1
(43) Pub. Date: Oct. 19, 2017

(54) Fireproof fabric and protective suit, in particular for motor sports, made of said fabric

(71) Applicant: ATELIER 13 SA, Chiasso (CH)

(72) Inventor: Fabiano VANETTI, Bodio Lonmago (VA) (IT)

(21) Appl. No.: 15/486,364

(22) Filed: Apr. 13, 2017

(30) Foreign Application Priority Data
Apr. 14, 2016 (EP) 16165234.2

(51) Int. Cl. A41D 31/00; A62B 17/00; A41D 13/02; D03D 15/12; D03D 15/08

(52) U.S. Cl. CPC A41D 31/0027; D03D 15/12; D03D 15/08; A41D 13/02; A62B 17/003; A41D 2400/22; A41D 2600/102

(57) ABSTRACT

Fireproof fabric comprising a set of warp threads (C1, . . . C6) and a set of weft threads, wherein said warp threads (C1, . . . C6) are arranged on a plurality of warp levels (A, B, C); all said warp levels are bound together by at least one weft thread (T5) acting as a binding thread and arranged so as to prevent relative slipping of said levels, and at least one of the set of weft threads and the set of warp threads is formed by elasticized threads, comprising a core of elastically deformable material lined with a fireproof material.

### FIELD OF THE INVENTION

The invention relates to the manufacture of fireproof fabrics, in particular for the sector of protective suits for practising motor sports.

### Prior Art

The term of fireproof fabric denotes a fabric having a combustion (ignition) resistance and able to represent a barrier against the transmission of heat. In other words, such a fabric, when exposed to a flame or even in direct contact therewith, shall not catch fire and shall provide protection against the high temperature at least for a certain period of time.

A field of application of fireproof fabrics which is of particular interest and with strict technical requirements is represented by the protective suits for motor sports.

A suit for motor sports must comply with the regulations prescribed by a competent regulating body such as, in the case of Formula 1 and various other categories, the FIA—Fédération International de l'Automobile. In general, the regulations prescribe subjecting a sample of the fabric to a number of tests which measure, among other things, the resistance to ignition and to passage of heat, and compliance with the test is an indispensable condition for homologation. As is known, exposure of the driver to a fire is a real risk, following an accident or also during refueling pit-stops, and the suit is greatly stressed in these emergency situations where it plays a crucial role for survival of the driver. Moreover, a fabric intended for suits for motor sports must have superior characteristics, also in terms of wearability and lightness, so as to ensure comfort and freedom of movement for the driver. Combining comfort and lightness with the necessary degree of safety is a particularly demanding technological challenge.

The known technology for manufacturing fireproof fabrics is based substantially on a multilayered (sandwich) design, in which each layer is made of fireproof material, and the layers are joined together by means of a series of stitches which are realized using an additional thread so as to form a stitched structure. For example a typical structure of fireproof fabric comprises an outer aramid fabric layer, having mainly a fire-barrier function; an intermediate layer formed by a felt or mesh lining, having mainly a barrier function for preventing the passage of heat; and an inner layer formed for example by an aramid mesh having the function of a lining and also of a protective barrier.

Said sandwich structure may achieve a satisfactory level of protection from fire and heat, although it has a number of drawbacks: the absolute lack of elasticity, mainly due to the fact that the heat-resistant fibers are inelastic and because of the stitching which rigidly joins the fabrics together; the low breathability, mainly due to the intermediate layer which acts as a barrier and does not allow rapid drying; the need to introduce heavy interlock-mesh inserts in the region of the articulations so as to allow movements despite the rigidity of the suit, adding complication to the structure and increasing the weight of the suit.

In the field of suits for motor sports, said sandwich structure, in general consisting of three layers, is widespread and constitutes a standard de facto. For this reason, there is a strong incentive to try to eliminate or reduce the aforementioned drawbacks. The rigidity of the suit and the poor breathability reduce the comfort and consequently may penalize the performance of the driver. The weight itself of the suit is not negligible because, as is well-known, any reduction in weight, even of a few hundred grams, may give a competitive advantage in motor sports and therefore there is an incentive to make the suit as light as possible in keeping with the degree of protection stipulated by the regulations. Moreover, the stitched structure and the rigidity of the fabric result in the need to manufacture the suit with a certain tolerance as regards the actual size worn by the pilot, i.e. the suit must not be very close-fitting, and this results in wastage of material, additional weight and a certain restriction of movement for the pilot.

In motor racing competitions attempts are made to optimize as far as possible each component, and the suit of the driver is not an exception being also subject to constant research for improvement; however it has not been possible so far to overcome the drawbacks mentioned above nor find a valid alternative to the multilayered stitched structure.

### SUMMARY OF THE INVENTION

The purpose of the present invention is to provide a fireproof fabric having the characteristics of being elastic and particularly lightweight, but at the same time with a high resistance to flame and heat. More specifically, an object of the invention is to provide a fabric suitable for manufacturing a protective suit having improved features of wearability and comfort and lighter in weight compared to conventional stitched multilayered suits. A further object is to improve the technology of protective suits, in particular for motor sports.

The objects are achieved with a fireproof fabric and with a protective suit according to the accompanying claims.

A fabric according to the invention comprises warp threads and weft threads; the warp threads are arranged on a plurality of levels; for each level one or more weft threads interwoven with the warp create a layer of fabric; moreover the layers of fabric are bound together by at least one of said weft threads, which acts as a single binding thread for said layers of fabric and prevents relative slipping of said layers. Moreover, the weft threads and/or the warp threads are elasticized threads, i.e. they comprise a core of elastically deformable material, for example an elastomer, covered by a fireproof material, for example an aramid fiber.

The terms of set of warp threads or set of weft threads, respectively, as used in the present description and in the claims, denote a plurality of warp threads and respectively of weft threads.

Advantageously, the invention provides that one of the set of warp threads and the set of weft threads is formed by threads having a glass-fiber core and a lining of fireproof material, and the other set of threads is formed by threads having an elastomer core and a lining of fireproof material. The core of the elasticized threads is advantageously made of a material able to provide a certain resistance to heat and flame-ignition, for example when an elastomer is used, a fire-retardant elastomer may be chosen.

The elasticity ensured by the use of the elasticized threads described is for example in the region of 20% to 30%.

More preferably, the warp threads are also made with a glass-fiber core and lining of fireproof material, and the weft threads are made with an elastomer (or polyethylene) core and lining of fireproof material.

The fireproof lining material is preferably an aramid or meta-aramid material, for example the material known by the trade name Nomex®.

Even more preferably, the threads with a glass-fiber core are lined with a long-staple aramid or meta-aramid material, while the threads with an elastomer core are lined with a short-staple aramid or meta-aramid material.

Advantageously, all the layers of fabric are bound together by said at least one weft binding thread. Said binding thread, more advantageously, passes around all the warp levels within a single warp pass.

According to various embodiments, one or more weft threads may serve as binding threads.

The preferred number of warp levels is three.

The warp levels may be formed by threads which are identical to each other, that is made of the same materials, or threads which are made of different materials.

The invention also relates to a protective suit made at least partially using a fireproof fabric according to any one of the accompanying claims. A preferred application of the invention consists in the manufacture of a protective suit for practising motor sports, in particular for motorcycle or motorcar racing. However, the invention is also applicable to protective suits for other uses.

When elasticized threads (with a core of elastic material and fireproof lining) are used for only one of the warp and weft (for example for the weft), the resultant fireproof fabric is of the monostretch type, having elastic properties in a first direction while being substantially rigid in a second direction perpendicular to said first direction.

In some embodiments elasticized threads may be used both for the warp and for the weft, obtaining a bistretch fabric. The formation of a monostretch fabric, however, may be preferred by way of a compromise between the features of comfort and wearability, which benefit from the elasticity, and the heat resistance.

For any of the weft threads and the warp threads, the lined structure may be formed with a core thread and at least one lining thread wound helically around said core thread. Preferably, two lining threads wound around a core thread are used, in accordance with a technique which is known as double lining This technique, in particular, provides insulation of the elastomer thread which is potentially the most exposed to heat or to flame-ignition.

A first big advantage of the invention is that the fabric has fireproof properties which are substantially equivalent to a multilayered sandwich composed of different materials, owing to the plurality of layers of fabric, but is lighter owing to the structure wherein layers are bound by an existing weft thread instead of an additional stitching thread. Binding is in fact performed directly on the loom, during the formation of the fabric by means of interweaving of warp and weft, differently from the prior art where different layers of different material are overlaid and stitched together by an additional thread. Another substantial advantage consists in the elasticity in at least one direction (monostretch) introduced by the use of threads having an elastic core.

These advantages result in a fireproof fabric which provides the same degree of protection as a conventional multilayered sandwich, but is lighter and elasticized and is also breathable, having no intermediate layer made of felt or other barrier material, which in conventional sandwich structures prevents almost completely the perspiration. Consequently, a protective suit made using the fabric according to the invention offers a series of improved characteristics: it is more comfortable, it can be made also without joining seats in the region of the articulations, owing to the elasticity, with a further weight reduction; by eliminating the stitching, a processing step can eliminated and the additional thread is eliminated; the suit can be cut more adherent to the body. The breathability ensures also faster drying of sweat.

These advantages are particularly important in the field of sports suits, especially for motorsport. Being more comfortable and breathable, the suit improves the comfort and the driving performance of the driver; the reduction in weight results directly in improvement of the speed performance; the possibility of making the suit tighter and tailored to fit the driver is another advantage. It should be noted that the prior art did not consider possible to produce a fabric which would be elasticized and, at the same time, able to ensure a sufficient fireproof protection to comply, for example, with the requirements of homologation tests applicable to protective suits for motorsport (for example the FIA tests). The invention overcomes this technical prejudice.

Another advantage is that the external appearance of the fabric is similar to that of a stitched fabric, owing to the binding of the weft thread, although the fabric according to the invention is substantially thinner and lighter. This makes the fabric according to the invention more readily acceptable, from a psychological point of view, for a driver used to layered suits. It should be considered that the driver must have absolute confidence in his equipment/clothing to concentrate on driving, and therefore this aspect is also of a considerable importance.

These and other advantages will become even clearer with reference to the following detailed description provided by way of example

### DESCRIPTION OF AN EMBODIMENT

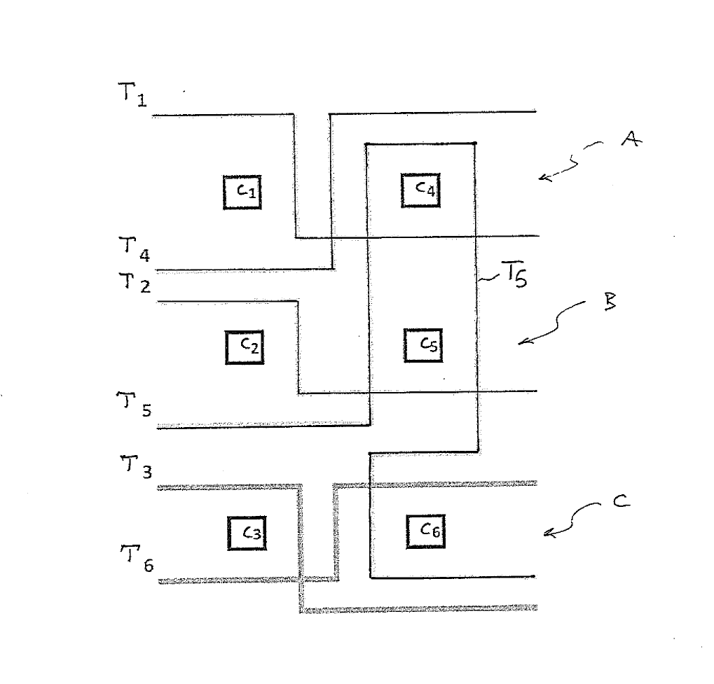

FIG. 1 shows in a schematic form the structure of a fireproof fabric in accordance with a preferred non-limiting mode of implementing the invention. Said figure relates to the example where the fabric comprises three layers bound by an existing weft thread.

The references C1, C2, . . . C6 denote warp threads which form three levels A, B, C. The warp threads are perpendicular to the plane of FIG. 1 and are separated by a pitch which is equivalent to the distance between the threads C1 and C4.

The references T1, T2, . . . T6 denote the path of the weft threads. At least one of the weft threads acts as a binding thread, being wound around all the warp levels A, B and C, so as to fasten them and prevent them from slipping on planes parallel to the said layers (parallel to the planes of the threads C1-C6). In FIG. 1 the weft thread T5 is the binding thread; for this purpose said weft thread T5 passes around all the threads of the warp in each passage, as can be noted from the figure, wherein the thread T5 passes around two first warp threads C4 and C5, respectively belonging to the layers A and B and then passes back around the remaining warp thread C6 of the layer C.

Preferably, the warp threads C1, . . . C6 are made with a glass-fiber core lined with aramid material. The weft threads T1, . . . T6 are instead made with an elastomer core also lined with aramid material. Consequently the fabric has a monodirectional elasticity in the direction of the weft threads.

It can be noted from FIG. 1 that the fabric leaves the loom in a triple-layer configuration, said configuration being obtained by the specific progression of the weft threads, at least one of them acting as a binding thread. The multilayered configuration is therefore an intrinsic feature of the fabric according to the invention, differently from the prior art where it is obtained subsequently by overlaying layers of different materials and stitching them together with an additional thread.

1. A fireproof fabric comprising a set of warp threads and a set of weft threads, wherein:
the warp threads are arranged on a plurality of warp levels;
all the warp levels are bound together by at least one weft thread acting as a binding thread and arranged so as to prevent relative slipping of said warp levels, and
at least one of the set of weft threads and the set of warp threads are elasticized threads comprising a core of elastically deformable material lined with a fireproof material.

2. The fireproof fabric according to claim 1, said elasticized threads comprising an elastomer core.

3. The fireproof fabric according to claim 2, wherein
one of the set of warp threads and the set of weft threads have a glass-fiber core and a lining of fireproof material, and
the other set of threads have an elastomer core and a lining of fireproof material.

4. The fireproof fabric according to claim 3, wherein the warp threads are made with a glass-fiber core and lining of fireproof material, and the weft threads are made with an elastomer core and lining of fireproof material.

5. The fireproof fabric according to claim 3, wherein the fireproof lining material is an aramid or meta-aramid material.

6. The fireproof fabric according to claim 5, wherein
the threads with glass-fiber core are lined with a long-staple aramid or long-staple meta-aramid fiber;
the threads with elastomer core are lined with a short-staple aramid or short-staple meta-aramid fiber.

7. The fireproof fabric according to claim 1 wherein all the warp levels are bound together by said at least one binding thread.

8. The fireproof fabric according to claim 7, wherein said at least one binding thread passes around all the warp levels for each pass of the warp.

9. The fireproof fabric according to claim 1, wherein only one of the set of warp threads and set of weft threads are elasticized threads, the fabric being then extensible only in one direction.

10. A method for manufacturing a fireproof fabric, comprising the following steps:
providing warp threads on a plurality of warp levels;
forming the fabric with weft threads and binding together said warp levels using at least one of the weft threads acting as a binding thread, and arranged to prevent relative slipping of said warp levels;
wherein at least one of the weft threads and warp threads are elasticized threads comprising a core of elastically deformable material lined with a fireproof material, resulting in the fireproof fabric being elasticized in at least one direction.

11. A protective suit made at least partially using a fireproof fabric according to claim 1.

12. The protective suit according to claim 11, for practising motor sports.

13. The protective suit according to claim 12, wherein the motor sports is motorcycle racing or auto racing.
